(19) United States
(12) Patent Application Publication
(10) Pub. No.: US 2019/0332249 A1
(43) Pub. Date: Oct. 31, 2019

(54) ROLLING INTERFACE OBJECT

(71) Applicant: HEWLETT PACKARD ENTERPRISE DEVELOPMENT LP, Houston, TX (US)

(72) Inventors: Srinath Nadig Sreekantaswamy, Bangalore (IN); Rajesh Anantha Krishnaiyer, Bangalore (IN); Parul Tyagi, Bangalore (IN); Kaviraj Doddaiah, Bangalore (IN)

(21) Appl. No.: 15/963,080

(22) Filed: Apr. 25, 2018

(51) Int. Cl. G06F 3/0484; G06F 3/0481

(52) U.S. Cl. CPC G06F 3/04842; G06F 3/04847; G06F 3/04812

(57) ABSTRACT

Example implementations relate to a rolling interface object. An example includes causing display, on a display device, of a plurality of data sets in respective display segments of a three-dimensional rolling interface object. At least some of the data sets include dynamic data. The display segments are arranged lengthwise on a surface of the rolling interface object. A primary segment of the display segments is in a foreground position, and background segments of the display segments are adjacent to the primary segment and visually diminished relative to the primary segment. Responsive to a command to roll the rolling interface object, the rolling interface object is changed as to which of the plurality of display segments is the primary segment.

### BACKGROUND

Graphical interfaces can be used to display many types of data. Data may include, for example, key performance indicators, time-based trends, resource utilization values, and other types. The visual presentation of data on graphical interfaces may enable users to intuitively understand the data.

### BRIEF DESCRIPTION OF THE DRAWINGS

Various examples will be described below with reference to the following figures.

FIG. 1 depicts an example rolling interface object.

FIG. 2 depicts an example rolling interface object.

FIG. 3 depicts an example rolling interface object with data set names.

FIG. 4 depicts an example rolling interface object in the form of an n-sided prism.

FIG. 5 depicts an example rolling interface object in the form of a cylinder.

FIG. 6 depicts an example rolling interface object in the form of an n-sided prism with tapered ends.

FIG. 7 depicts an example rolling interface object in the form of a cylinder with tapered ends.

FIG. 8A depicts an example rolling interface object with data set names.

FIG. 8B depicts an example flat dashboard associated with the rolling interface object of FIG. 8A.

FIG. 9 is a block diagram depicting an example system that includes a non-transitory, machine readable medium encoded with example instructions to cause display of a rolling interface object.

FIG. 10 is a block diagram depicting an example system that includes a non-transitory, machine readable medium encoded with example instructions to respond to commands.

FIG. 11 depicts an example method for causing display of a rolling interface object.

### DETAILED DESCRIPTION

Graphical interfaces can be used to display many types of data on a screen or other display device. For example, graphical dashboards are a type of graphical interface that lay out graphical elements (e.g., graphs, charts, numerical or textual data, user input options, etc.) side by side. Data may include, for example, key performance indicators (KPIs), time-based trends, resource utilization values, and other types. In particular, a dashboard may plot parameters of a computing system or environment, such as CPU, memory, disk, or networking usage trends. Moreover, artificial intelligence, machine learning, and other analytical techniques may be applied to data, and the output, such as insights and predictions to future values, may be presented in graphical interfaces.

Visually presenting data on graphical interfaces may enable users to more intuitively understand the data. For example, graphical interfaces may provide quick and efficient at-a-glance views of data. Graphical interfaces may also assist users in comparing data to identify aberrations, positive or negative trends, efficiencies and inefficiencies, and the like. Users may then make informed decisions based on the understanding gained.

However, the ever-increasing complexity and pace of society and modern technology is resulting in an increasing amount, complexity, and interdependence of many types of data. Many graphical interfaces fail to cope with such changes in the volume and complexity of data. For example, dashboards may consume significant display real estate in order to present the data. As a result, dashboards may be less useful for assisting users to efficiently focus on relevant data for monitoring and decision-making tasks. Designing useful dashboards is a significant technical challenge for user experience engineers and designers.

Accordingly, it may be useful to provide a three-dimensional rolling interface object on a display device, via a computing system. The interface object may be in the form of an n-sided prism or a cylinder. Different data sets or different views of a same data set may be displayed on lengthwise segments of the rolling interface object, where a primary segment is in a foreground position. The rolling interface object may be controlled to roll the object to display a different segment in the foreground position. By virtue of a rolling interface object, large amounts of data and/or disparate data may be presented to a user in an intuitive and efficient manner.

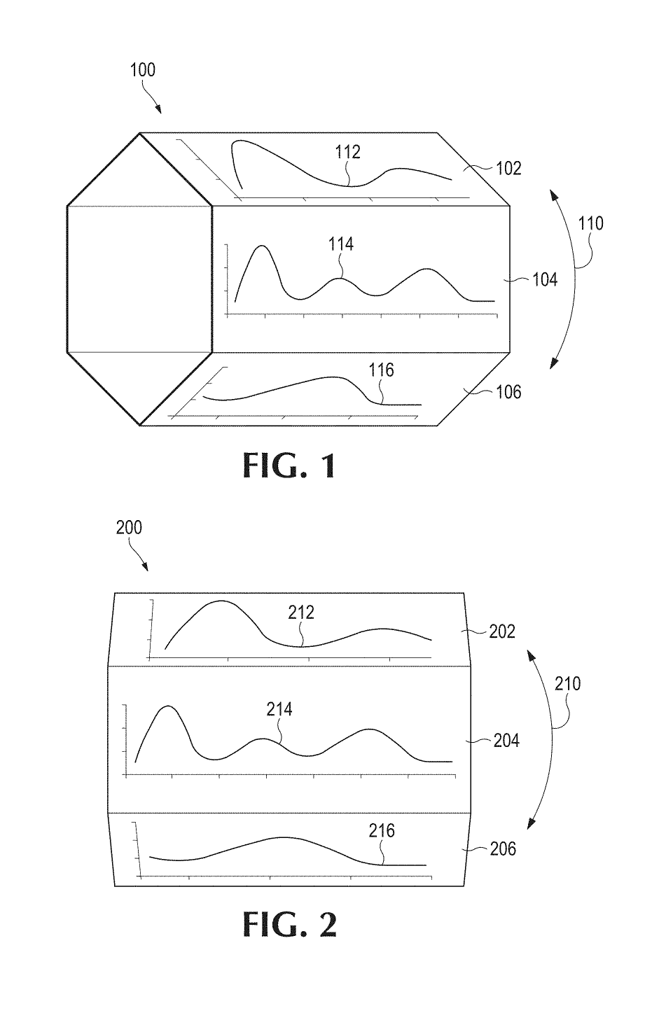

As will be described, FIGS. 1-7, 8A, and 8B depict various example rolling interface objects and aspects thereof. Such example rolling interface objects may be displayed on a display device, such as a monitor, a touchscreen display, a mobile device display, etc. A combination of hardware and programming may be utilized to cause display of (e.g., to render) a rolling interface object on the display device and to receive commands related to the rolling interface object as will be described further herein below. As referred to herein, programming may be executable instructions stored on a non-transitory machine-readable storage medium, and the hardware may include at least one processing resource to retrieve and/or execute those instructions. A processing resource may include a microcontroller, a microprocessor, central processing unit core(s), an application-specific integrated circuit (ASIC), a field programmable gate array (FPGA), etc. A non-transitory machine readable medium may include random access memory (RAM), read-only memory (ROM), electrically erasable programmable read-only memory (EEPROM), flash memory, a hard disk drive, etc. The term “non-transitory” does not encompass transitory propagating signals. Additionally or alternatively, hardware may include electronic circuitry or logic for implementing functionality described herein.

FIG. 1 depicts an example three-dimensional rolling interface object 100 that can be displayed on a display device. Although the rolling interface object 100 is illustrated as a six sided prism, other variations may be implemented, that is, interface object 100 may be an n-sided prism (where “n” is an integer). The rolling interface object 100 includes a plurality of display segments 102, 104, 106. In the example of FIG. 1, the display segments 102, 104, 106 are side surfaces of the n-sided prism that forms the rolling interface object 100. Said another way, the display segments 102, 104, 106 are lengthwise on a surface of the rolling interface object 100 and are adjacent to each other in a rotational direction 110 of the rolling interface object 100.

Data sets may be displayed in respective display segments of the rolling interface object 100. As an illustration, the example of FIG. 1 depicts a data set 112 displayed in the display segment 102, a data set 114 displayed in the display segment 104, and a data set 116 displayed in the display segment 106.

The display segment 104 is in a foreground position, and may be described as a primary segment. The adjacent display segments 102, 106 are visually diminished relative to the primary segment, display segment 104. Thus, the adjacent display segments 102, 106 may be described as background segments. For example, the background segments may be angled, skewed, and/or slighter than the primary segment, owing to the perspective and geometry of the rolling interface object 100. By virtue of the background segments being visually diminished, the rolling interface object 100 may help a user focus on the data presented in the primary segment. Moreover, the adjacency of the background segments may provide context for viewing and interpreting the primary segment.

At least some of the data sets include dynamic data. For example, dynamic data may be updated over time, and may include monitoring data (e.g., data from monitored resources such as CPU, memory, storage, networking, power, thermal, etc.), KPIs, or the like. The data may be related or unrelated to the computing system causing display of the rolling interface object 100. In this manner, dynamic data may be presented to a user for monitoring, analysis, and/or decision making. In other implementations, some of the data sets may include static elements, such as menu options.

In some cases, some of the plurality of data sets may be of unrelated data types. For example, data sets 112 and 114 may be resource monitoring data from different respective computing systems. In an implementation, adjacent display segments may display the same data set with different scaling. For example, in the illustration of FIG. 1, the data sets 112, 114, 116 may be the same data set, but displayed with different axis scaling, and in particular, x-axis scaling (e.g., different time scales).

A user may utilize controls to input a command to roll the rolling interface object 100 along the rotational direction 110. For example, the controls may include a mouse, a keyboard, a touchscreen interface, a gesture-based interface, or other type of interface device. In other examples, the command to roll may be provided by a computing system, may be issued by a system at time intervals, or may be triggered by an event (e.g., an alert). In response to the command, the rolling interface object 100 may be updated on the display device to show a different display segment as the primary segment (and thus a different data set in the foreground), as well as different display segments as the background segments. The rolling interface object 100 may be animated to simulate a rotation or rolling of the object 100. In this manner, a user may select desired data to review on the primary segment. For example, in FIG. 1, three additional display segments and corresponding data sets are not visible because they are on a back side of the rolling interface object 100. A roll command may cause those back side segments to become visible in the primary and background segments (e.g., like 102, 104, 106).

A user may utilize controls to issue a command to change the data set displayed in a particular display segment to a different data set such as a data set not already displayed on the rolling interface object 100. In response, that particular display segment may be updated to display the different data set. For example, controls for commanding a change in data set may include mouse, a keyboard, a touchscreen interface, a gesture-based interface, or other type of interface device.

FIG. 2 depicts an example three-dimensional rolling interface object 200 that can be displayed on a display device. The rolling interface object 200 may be similar in many respects to the rolling interface object 100. For example, the rolling interface object 200 may be an n-sided prism with a plurality of display segments 202, 204, 206 that are similar to display segments 102, 104, 106. For example, the display segments 202, 204, 206 are arranged lengthwise on surfaces of the rolling interface object 200 and adjacent to each other along a rotational direction 210. The display segments 202, 204, 206 may have displayed thereon respective data sets 212, 214, 216. Display segment 204 may be a primary segment while display segments 202, 206 may be background segments. The rolling interface object 200 may be rolled in a rotational direction 210 to display different display segments (and corresponding data sets) in the primary segment.

The rolling interface object 200 is rendered in a head-on perspective, rather than in an oblique or angled perspective as is the rolling interface object 100 of FIG. 1. The head-on perspective may be applied to other example rolling interface objects described herein.

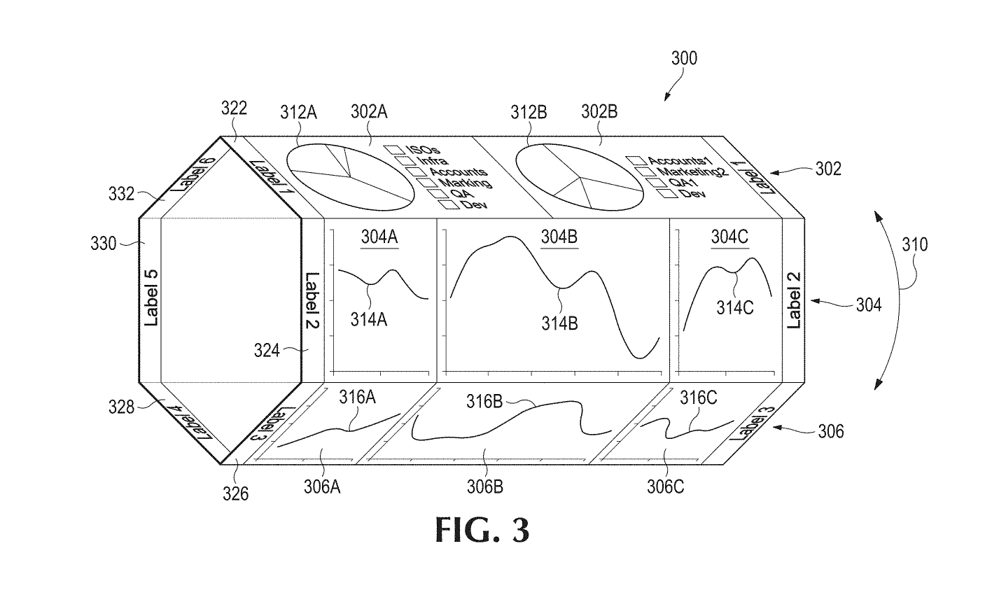

FIG. 3 depicts an example three-dimensional rolling interface object 300 that can be displayed on a display device. The rolling interface object 300 may be similar in many respects to the rolling interface object 100. For example, the rolling interface object 300 may be an n-sided prism with a plurality of display segments 302, 304, 306 that are similar to display segments 102, 104, 106. The rolling interface object 300 may be rolled along a rotational direction 310 to show different display segments as a primary display segment in a foreground position.

In some cases, one or more of the plurality of display segments 302, 304, 306 (as well as display segments not visible), may be divided into sub-segments in some cases. For example, in some implementations, a design interface may be provided whereby a user selects whether a display segment is divided and what data sets to display in sub-segments. Sub-segments may be utilized to display data sets, and in some examples, to display different data sets or different views of a same data set (e.g., different scale, different portion of the same data set such as a past or future prediction, etc.). Display segments may be divided into different numbers of sub-segments.

In the example of FIG. 3, the display segment 302 is divided into sub-segments 302A, 302B, which are used to display data sets 312A, 312B respectively. The display segment 304 is divided into sub-segments 304A, 304B, 304C, which are used to display data sets 314A, 314B, 314C respectively. The display segment 306 is divided into sub-segments 306A, 306B, 306C, which are used to display data sets 316A, 316B, 316C respectively. As an example, data set 314B may be a representation of a current trend of a monitored variable, data set 314A may be a historical trend of the same monitored variable, and data set 314C may be a predicted future trend of the same monitored variable.

In some implementations, different types of graphics may be employed to display at least some of the plurality of data sets. To illustrate, in the example of FIG. 3, the data sets 314A, 314B, 314C, 316A, 316B, 316C are graphs, while the data sets 312A, 312B are pie charts. Other types of graphics also are contemplated, such as bar charts, scatter plots, radar charts, 3D charts, lists of numerical or text data, etc.

In some implementations, a data set name may be displayed for some or all of the plurality of data sets. For example, as illustrated in FIG. 3, data set names 322, 324, 326 (i.e., labels) are displayed for data sets at the end of respective display segments 302, 304, 306. Moreover, data set names 328, 330, 332 are displayed at the end of display segments that are not visible when such display segments are on a back side of the rolling interface object 300.

In some implementations, selection of a particular data set name (e.g., by a user operating controls) may cause display on the rolling interface object 300 of the associated data set in the primary segment, that is, in the foreground. Selection of a data set name and responsive display of the data set in this manner may serve as an additional and/or alternative method of navigating the rolling interface object 300, that is, in addition to or alternatively to rolling through the interface object 300.

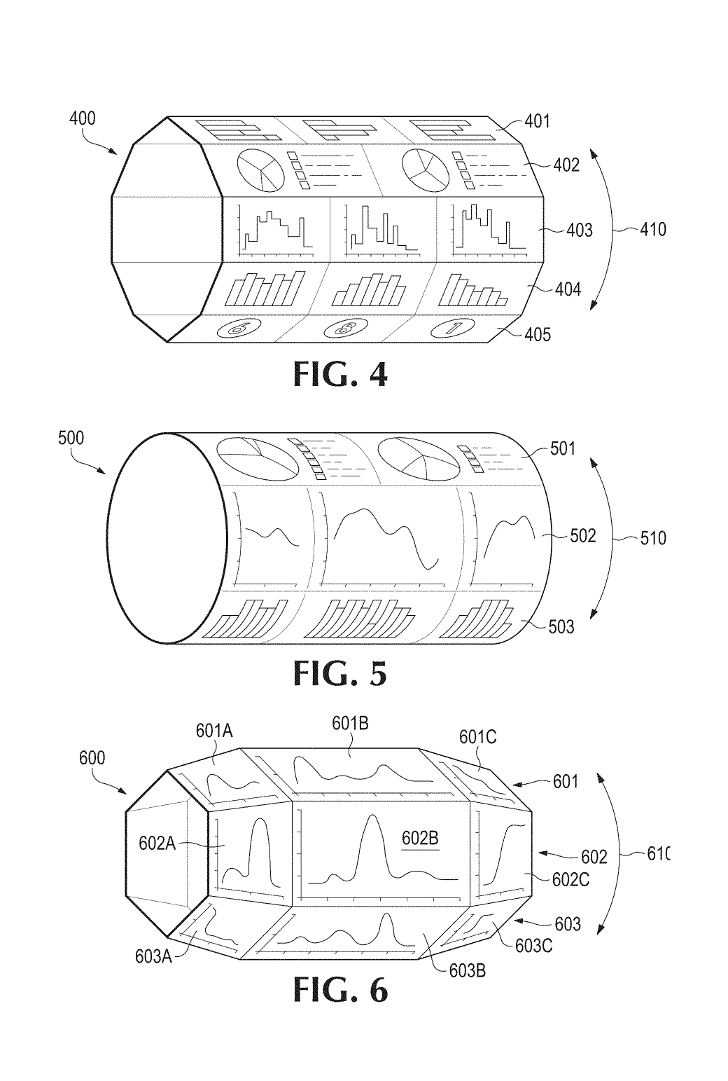

FIG. 4 depicts an example three-dimensional rolling interface object 400 that can be displayed on a display device. The rolling interface object 400 may be similar in many respects to the rolling interface object 100, and for example, is in the form of an n-sided prism, in particular a ten-sided prism. The rolling interface object 400 has visible display segments 401, 402, 403, 404, 405, where display segment 403 is the primary segment in the foreground. The rolling interface object 400 may be rolled in a rotational direction 410 to display other display segments as the primary segment.

FIG. 5 depicts an example three-dimensional rolling interface object 500 that can be displayed on a display device. The rolling interface object 500 is in the form of a cylinder, and has visible display segments 501, 502, 503. The display segments 501, 502, 503 may function similarly to the display segments 102, 104, 106 or other display segments described herein, for display data sets. The rolling interface object 500 may be rolled in a rotational direction 510 to change the display segment and data set shown in the foreground (i.e., as the primary segment).

FIG. 6 depicts an example three-dimensional rolling interface object 600 that can be displayed on a display device. The rolling interface object 600 may be in the form of an n-sided prism tapered at opposite ends. Like other rolling interface objects described herein, the rolling interface object 600 has visible display segments 601, 602, 603. Such a shape may be deemed to resemble a barrel. The rolling interface object 600 may be rolled in a rotational direction 610 to change the display segment and data set shown in the foreground position (i.e., as the primary segment).

In some implementations, a display segment 601, 602, 603 may be further segmented by the tapering, which may be useful for displaying different data sets or different views of a same data set. Thus, the rolling interface object 600 has tapered end sub-segments 601A, 602A, 603A, 601C, 602C, 603C, and center regions 601B, 602B, 603B. The center region 602B of the foreground position in particular is emphasized, thus enabling a user to focus on the data set displayed in that region 602B, with the context of data sets displayed in the adjacent regions. In other implementations, display segments need not be segmented and a data set may be displayed across the full tapered display segment.

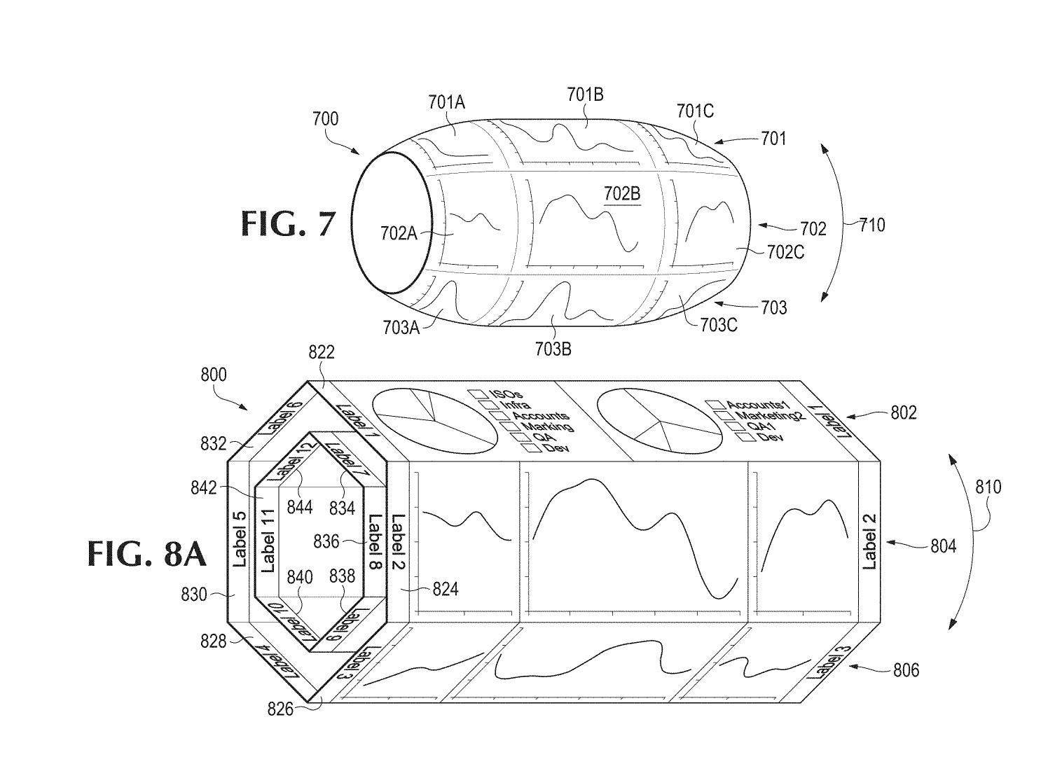

FIG. 7 depicts an example three-dimensional rolling interface object 700 that can be displayed on a display device. The rolling interface object 700 may be similar in many respects to the rolling interface object 600 (an n-sided prism with tapered ends), but in the form of a cylinder with tapered ends. The rolling interface object 700 has visible display segments 701, 702, 703. In some examples, a display segment may be segmented between tapered regions (e.g., 701A, 702A, 703A, 701C, 702C, 703C) and non-tapered regions (701B, 702B, 703B), to show different data sets or different views of a same data set in the tapered and non-tapered regions. In other examples, a display segment need not be segmented and a data set may be displayed across the entire tapered display segment. The rolling interface object 700 may be rolled in a rotational direction 710 to change the display segment and data set shown in the foreground position (i.e., as the primary segment).

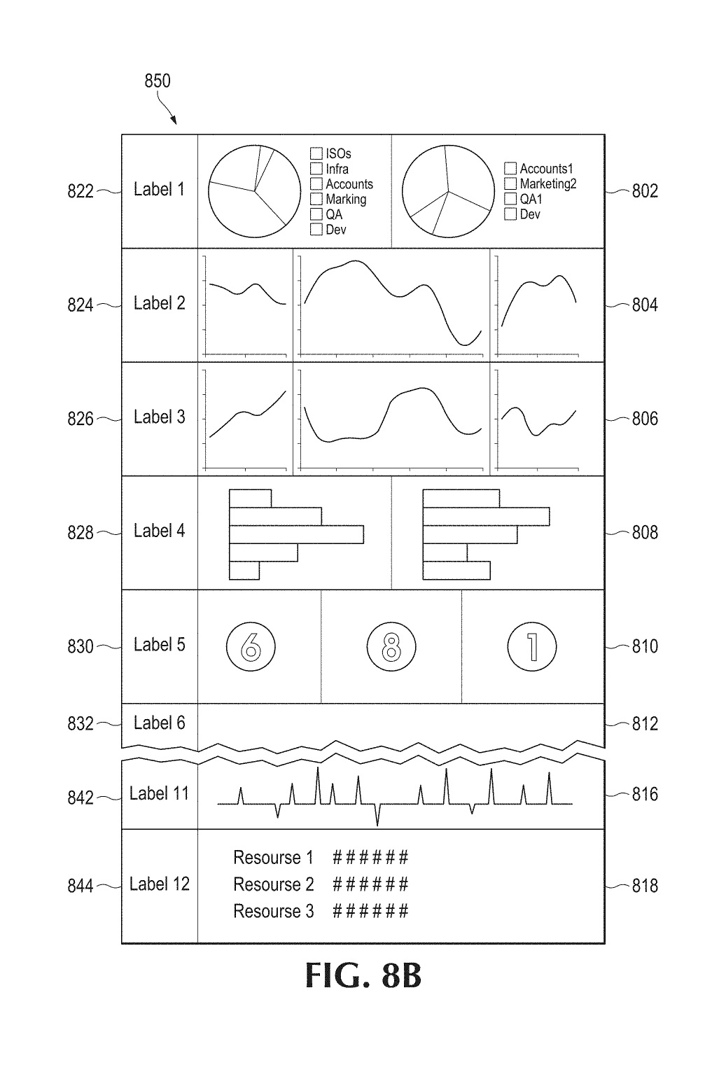

FIG. 8A depicts an example three-dimensional rolling interface object 800 that can be displayed on a display device. The rolling interface object 800 may be similar in many respects to the rolling interface object 300, in that the rolling interface object 800 includes data set names 822, 824, 826, for visible display segments 802, 804, 806 respectively, as well as data set names 828, 830, 832 for display segments on a back side of the object 800 that are not visible in the illustration of FIG. 8A. Also, the rolling interface object 800 may be rolled in a rotational direction 810 to change the visible display segments and to change which display segment is the primary segment in the foreground.

The rolling interface object 800 also includes additional data sets that are not visible when the object 800 is rolling or at a standstill. The additional data sets are represented by data set names 834, 836, 838, 840, 842, 844. When a data set name of the additional data sets is selected (e.g., by a user operating controls), the rolling interface object 800 may visually transition (e.g., in an unrolling animation) to a display of an expanded flat dashboard, such as that illustrated in FIG. 8B, to display the additional data sets.

FIG. 8B depicts an example flat dashboard 850 associated with the rolling interface object of FIG. 8A. The flat dashboard 850 displays the display segments 802, 804, 806 that are visible on the rolling interface object 800 of FIG. 8B with the corresponding data set names 822, 824, 826, as well as display segments 808, 810, 812 that are on the back side of the rolling interface object 800 as illustrated in FIG. 8B (but may be visible if the object 800 were rolled along direction 810) with the corresponding data set names 828, 830, 832. Moreover, the flat dashboard 850 displays display segments with the additional data sets in FIG. 8B, including display segment 816 and 818, having data set names 842, 844 respectively (others of the additional data sets are not shown, for convenience, as represented by the break in FIG. 8B).

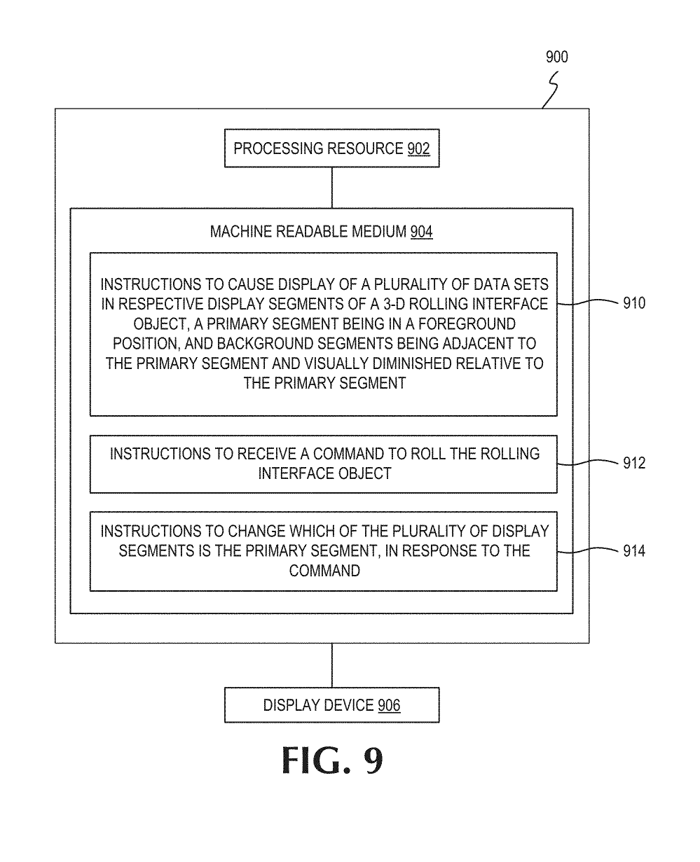

FIG. 9 depicts an example system 900 that includes a processing resource 902 coupled to a non-transitory, machine readable medium 904 encoded with example instructions 910, 912, 914. The processing resource 902 may include a microcontroller, a microprocessor, central processing unit core(s), graphics processing unit(s), an ASIC, an FPGA, and/or other hardware device suitable for retrieval and/or execution of instructions from the machine readable medium 904 to perform functions related to various examples. Additionally or alternatively, the processing resource 902 may include electronic circuitry for performing the functionality of the instructions described herein.

The machine readable medium 904 may be any medium suitable for storing executable instructions, such as RAM, ROM, EEPROM, flash memory, a hard disk drive, an optical disc, or the like. The machine readable medium 904 may be disposed within a system (e.g., a server or the like), in which case the executable instructions may be deemed “installed” on or “embedded” in the system. Alternatively, the machine readable medium 904 may be a portable (e.g., external) storage medium, and may be part of an “installation package.”

As described further herein below, the machine readable medium 904 may be encoded with a set of executable instructions 910, 912, 914. It should be understood that all or part of the executable instructions and/or electronic circuits included within one box may, in alternate implementations, be included in a different box shown in the figures or in a different box not shown. In some examples, the instructions 910, 912, 914 may be useful for causing display on a display device 906 in communication with the system 900 of a three-dimensional rolling interface object and for handling related interactions. The display device 906 may be, e.g., a monitor, a touchscreen, or other display technology. Aspects of the system 900 may be described below with reference to preceding example rolling interface objects, such as object 100, although the system 900 is not limited to those examples.

Instructions 910, when executed, cause the processing resource 902 to cause display, on the display device 906, of a plurality of data sets 112, 114, 116 in respective display segments 102, 104, 106 of a three-dimensional rolling interface object 100. At least some of the data sets include dynamic data. In some examples, at least some of the plurality of data sets are of unrelated data types. In some examples, some of the data sets displayed in the display segments may be the same data set with different scaling in adjacent display segments. In some implementations, instructions 910 may cause display of at least some of the plurality of data sets using different types of graphics (e.g., graphs, pie charts, etc.). The display segments 102, 104, 106 are arranged lengthwise on a surface of the rolling interface object 100 and are adjacent to each other along a rotational direction 110 of the rolling interface object 100. By virtue of the geometry of the rolling interface object 100, a primary segment 104 of the display segments is in a foreground position and background segments 102, 106 of the display segments are adjacent to the primary segment 104 and visually diminished relative to the primary segment 104. In some implementations, a display segment may be divided into sub-segments (e.g., 304A, 304B, 304C), each of the sub-segments for displaying respective data sets (e.g., 314A, 314B, 314C).

In some implementations, instructions 910 may render the rolling interface object in the form of an n-sided prism (e.g., object 100 or 400). In some implementations, instructions 910 may render the rolling interface object in the form of a cylinder (e.g., object 500). In some implementations, instructions 910 may render the rolling interface object as tapered at opposite ends (e.g., object 600 or 700), which emphasizes a center region (e.g., region 602B or 702B) of the foreground position (e.g., display segment 602 or 702).

Instructions 912, when executed, cause the processing resource 902 to receive a command to roll the rolling interface object 100. For example, the command may be received from a mouse, a keyboard, a touchscreen interface, a gesture-based interface, or other type of interface device. Instructions 914, when executed, cause the processing resource 902 to respond to the command received via instructions 912 by changing which of the plurality of display segments and corresponding data set is shown in the foreground, that is, as the primary segment 104. Instructions 914 may cause display of a rolling animation of the object 100.

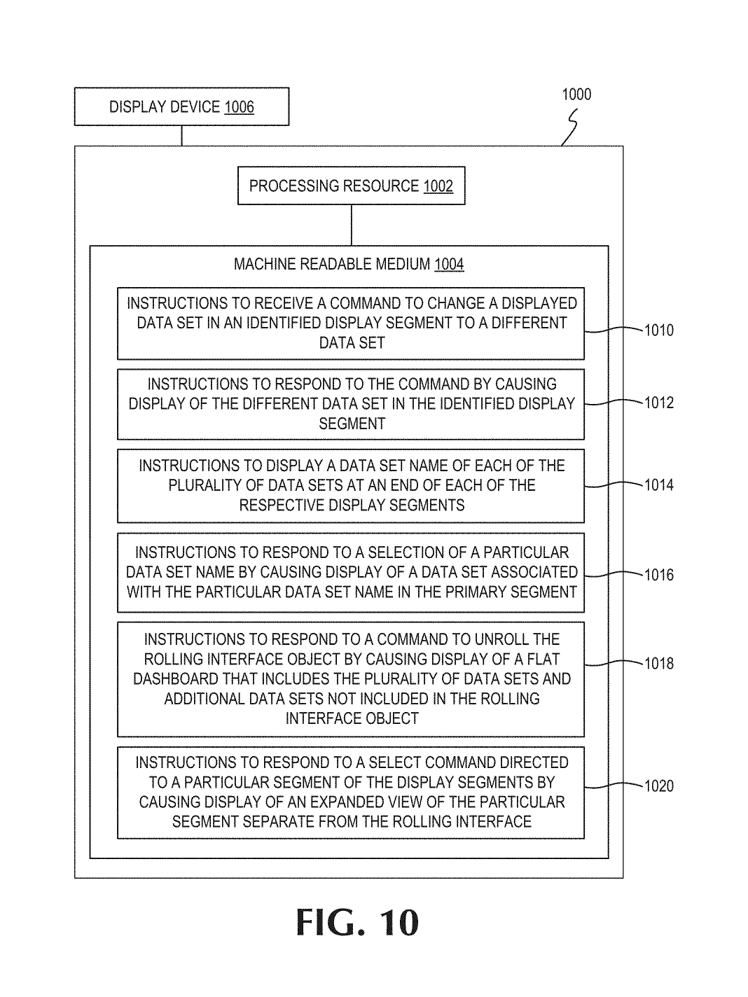

FIG. 10 depicts an example system 1000 that includes a processing resource 1002 coupled to a non-transitory, machine readable medium 1004 encoded with example instructions. The processing resource 1002 and the machine readable medium 1004 may be analogous in many respects to the processing resource 902 and the machine readable medium 904, respectively.

The machine readable medium 1004 may be encoded with a set of executable instructions 1010-1020. It should be understood that part or all of the executable instructions and/or electronic circuits included within one box may, in alternate implementations, be included in a different box shown in the figures or in a different box not shown. Some implementations may include more or fewer instructions than are shown in FIG. 10. In some implementations, one or more of the instructions 1010-1020 may operate in combination (e.g., sequentially or concurrently) with one or more of the instructions 910, 912, 914 of FIG. 9. The instructions 1010-1020 may be useful for causing display on a display device 1006 in communication with the system 1000 of a three-dimensional rolling interface object and for handling related interactions. Aspects of the system 1000 may be described below with reference to preceding example rolling interface objects, such as object 100, although the system 1000 is not limited to those examples.

Instructions 1010, when executed, cause the processing resource 1002 to receive a command to change a displayed data set in an identified display segment to a different data set. The command may be received from a mouse, a keyboard, a touchscreen interface, a gesture-based interface, or other type of interface device. The command may include, as parameters, the identified display segment and the different data set. Instructions 1012, when executed, cause the processing resource 1002 to respond to the command received via instructions 1010 by causing display of the different data set in the identified display segment. For example, instructions 1010, 1012 may enable a user to change the data set displayed in display segment 104.

Instructions 1014, when executed, cause the processing resource 1002 to display a data set name 322, 324, 326, 328, 330, 332 of each of the plurality of data sets at an end of each of the respective display segments. The data set names may be displayed also for display segments that are not visible on the rolling interface object 300, because those display segments are on a back side of the object 300 as rendered. Instructions 1016, when executed, cause the processing resource 1002 to respond to a selection of a particular data set name (e.g., from among 322, 324, 326, 328, 330, 332) by causing display of a data set associated with that particular data set name in the primary segment, that is, in the foreground. For example, in response to a user selecting data set name 332, the processing resource 1002 executing instructions 1014, 1016 will cause display of the corresponding data set (not visible in FIG. 3) in the primary segment, that is, where display segment 304 is depicted in FIG. 3. Instructions 1016 may cause a rolling animation of the object 300 when transitioning to the selected data set. The selection may be made using a mouse, a keyboard, a touchscreen interface, a gesture-based interface, or other type of interface device.

Instructions 1018, when executed, cause the processing resource 1002 to respond to a command to unroll the rolling interface object 800 by causing display of a flat dashboard 850 that includes the plurality of data sets (shown in segments 802, 804, 806, 808, 810, 812) and additional data sets not visible in the rolling interface object (shown in segments 816, 818). A command to unroll may include selection of a data set name 834, 836, 838, 840, 842, or 844 of one of the additional data sets not visible in the rolling interface object 800 or selection of a separate “unroll” command (e.g., a button).

Instructions 1020, when executed, cause the processing resource 1002 to respond to a select command directed to a particular segment of the display segments by causing display on the display device of an expanded view of the particular segment separate from the rolling interface. The select command may be made using a mouse, a keyboard, a touchscreen interface, a gesture-based interface, or other type of interface device. For example, a user may select data segment 102 in FIG. 1, and in response, the data set 112 is displayed in an expanded view, such as a pop-out window, an overlaid display, or the like. The expanded view may be enlarged and/or non-skewed, relative to the corresponding display segment in the rolling interface object.

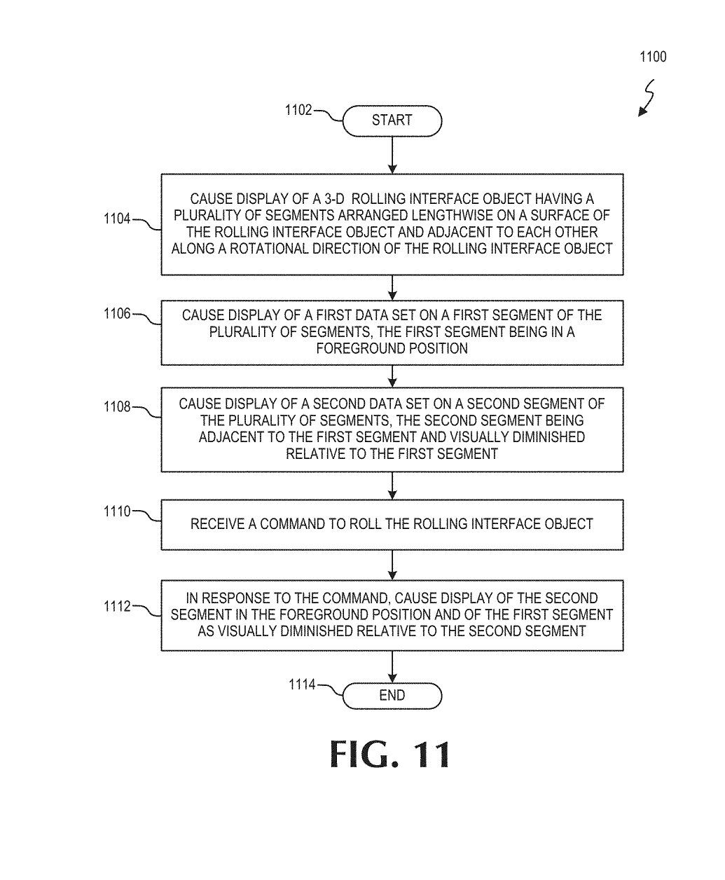

FIG. 11 depicts an example method 1100. One or more blocks of the method may be executed substantially concurrently or in a different order than shown. In some implementations, a method may include more or fewer blocks than are shown. In some implementations, one or more of the blocks of a method may, at certain times, be ongoing and/or may repeat.

Method 1100 may be implemented in the form of executable instructions stored on a machine readable medium and executed by a processing resource and/or in the form of electronic circuitry. For example, method 1100 below may be performed in part or in whole by a system such as system 900 or 1000 that includes a processing resource. Method 1100 may be described below with reference to example elements described above but is not limited to those examples.

The method 1100 starts at block 1102 and continues to block 1104, where a processing resource causes display on a display device of a three-dimensional rolling interface object 100 having a plurality of segments 102, 104, 106. The segments are arranged lengthwise on a surface of the rolling interface object 100 and are adjacent to each other along a rotational direction 110 of the rolling interface object 100. The rolling interface object may be in the form of a cylinder (e.g., 500) or an n-sided prism (e.g., 100, 400). In some implementations, the rolling interface object may be tapered at opposite ends and a center region of the foreground position may thus be emphasized (e.g., 600 or 700).

At block 1106, the processing resource causes display on a display device of a first data set 114 on a first segment 104 of the plurality of segments. The first segment is in a foreground position.

At block 1108, the processing resource causes display on the display device of a second data set 112 or 116 on a second segment 102 or 106 of the plurality of segments. The second segment 102 or 106 is adjacent to the first segment 104 and visually diminished relative to the first segment 104. For example, visually diminished may mean that the second segment is less prominent, is smaller, is skewed, or the like, relative to the first segment.

The first data set or the second data set includes dynamic data. That is, dynamic data may include data that is updated over time. In some cases, the first data set and the second data set may be of unrelated data types. In some cases, the first data set and the second data set may be differently scaled instances of the same data set.

At block 1110, the processing resource receives a command to roll the rolling interface object 100. For example, the command may come from a mouse, a keyboard, a touchscreen display, another computer instruction, etc.

At block 1112, the processing resource responds to the command by causing display on the display device of the second segment in the foreground position and of the first segment as visually diminished relative to the second segment. For example, if in the illustration of FIG. 1, the command was to roll the rolling interface object 100 downwards (with respect to rotational direction 110), the display segment 104 and the data set 114 thereon would shift to the background position occupied by display segment 106 and data set 116 and the display segment 102 and the data set 112 thereon would shift to the foreground position previously occupied by the display segment 104 and the data set 114 thereof.

At block 1114, method 1100 ends. In some implementations, method 1100 may include alternative and/or additional steps, particularly to provide the functionality described above with respect to FIGS. 1-8B.

For example, in some implementations, the method 1100 may include blocks wherein the processing resource receives a select command (i.e., a command making a selection) directed to a particular segment of the plurality of segments and causes display on the display device of an expanded view of the particular segment in response to the select command.

In some implementations, the method 1100 may include blocks wherein the processing resource responds to a command to unroll the rolling interface object 800 by causing display of a flat two-dimensional dashboard 850 that includes the plurality of data sets and additional data sets not visible in the rolling interface object 800. For example, the command to unroll may include a selection of a data set name 834, 836, 838, 840, 842, 844 that corresponds to an additional data set that is not visible in the rolling interface object 800.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications, combinations, and variations.

What is claimed:

1. A non-transitory machine readable medium storing instructions executable by a processing resource, the non-transitory machine readable medium comprising:
instructions to cause display, on a display device, of a plurality of data sets in respective display segments of a three-dimensional rolling interface object, wherein the display segments are arranged lengthwise on a surface of the rolling interface object and are adjacent to each other along a rotational direction of the rolling interface object, a primary segment of the display segments being in a foreground position, and background segments of the display segments are adjacent to the primary segment and visually diminished relative to the primary segment;
instructions to receive a command to roll the rolling interface object; and
instructions to change which of the display segments is the primary segment, in response to the command;
wherein at least some of the data sets include dynamic data.

2. The non-transitory machine readable medium of claim 1, wherein the rolling interface object is in the form of a cylinder or an n-sided prism.

3. The non-transitory machine readable medium of claim 1, further comprising:
instructions to receive a command to change a displayed data set in an identified display segment to a different data set; and
instructions to respond to the command by causing display of the different data set in the identified display segment.

4. The non-transitory machine readable medium of claim 1, further comprising:
instructions to display a data set name of each of the plurality of data sets at an end of each of the respective display segments; and
instructions to respond to a selection of a particular data set name by causing display of a data set associated with the particular data set name in the primary segment.

5. The non-transitory machine readable medium of claim 1, further comprising:
instructions to respond to a command to unroll the rolling interface object by causing display of a flat dashboard that includes the plurality of data sets and additional data sets not visible in the rolling interface object.

6. The non-transitory machine readable medium of claim 1, wherein the rolling interface object is tapered at opposite ends, and a center region of the foreground position is emphasized.

7. The non-transitory machine readable medium of claim 1, further comprising:
instructions to respond to a select command directed to a particular segment of the display segments by causing display on the display device of an expanded view of the particular segment separate from the rolling interface.

8. The non-transitory machine readable medium of claim 1, wherein at least some of the plurality of data sets are of unrelated data types.

9. The non-transitory machine readable medium of claim 1, wherein the instructions to cause display, on the display device, of the plurality of data sets are to cause display of the same data set with different scaling in adjacent display segments.

10. The non-transitory machine readable medium of claim 1, wherein the instructions to cause display, on the display device, of the plurality of data sets utilizes different types of graphics to display at least some of the plurality of data sets.

11. The non-transitory machine readable medium of claim 1, wherein the primary segment is divided into sub-segments, each of the sub-segments for displaying respective data sets.

12. A system comprising:
a processing resource; and
a non-transitory machine readable medium storing instructions that, when executed, cause the processing resource to:
cause display, on a display device, of a plurality of data sets in respective display segments of a three-dimensional rolling interface object, wherein the display segments are arranged lengthwise on a surface of the rolling interface object and are adjacent to each other along a rotational direction of the rolling interface object, a primary segment of the display segments being in a foreground position, and background segments of the display segments are adjacent to the primary segment and visually diminished relative to the primary segment;
receive a command to roll the rolling interface object; and
responsive to the command, change which of the plurality of display segments is the primary segment,
wherein at least some of the data sets include dynamic data.

13. The system of claim 12, wherein the rolling interface object is tapered at opposite ends, and a center region of the foreground position is emphasized.

14. The system of claim 12, wherein the non-transitory machine readable medium stores instructions that cause the processing resource to:
respond to a command to unroll the rolling interface object by causing display of a flat dashboard that includes the plurality of data sets and additional data sets not visible in the rolling interface object.

15. A method comprising:
causing display on a display device, by a processing resource, of a three-dimensional rolling interface object having a plurality of segments, the segments being arranged lengthwise on a surface of the rolling interface object and being adjacent to each other along a rotational direction of the rolling interface object;
causing display on a display device, by the processing resource, of a first data set on a first segment of the plurality of segments, the first segment being in a foreground position;
causing display on the display device, by the processing resource, of a second data set on a second segment of the plurality of segments, the second segment being adjacent to the first segment and visually diminished relative to the first segment;
receiving, by the processing resource, a command to roll the rolling interface object; and
in response to the command, causing display on the display device, by the processing resource, of the second segment in the foreground position and of the first segment as visually diminished relative to the second segment,
wherein the first data set or the second data set includes dynamic data, and
the rolling interface object is in the form of a cylinder or an n-sided prism.

16. The method of claim 15, wherein the rolling interface object is tapered at opposite ends and a center region of the foreground position is emphasized.

17. The method of claim 15, further comprising:
receiving, by the processing resource, a select command directed to a particular segment of the plurality of segments; and
causing display on the display device, by the processing resource, an expanded view of the particular segment.

18. The method of claim 15, wherein the first data set and the second data set are of unrelated data types.

19. The method of claim 15, wherein the first data set and the second data set are differently scaled instances of the same data set.

20. The method of claim 15, further comprising:
responding to a command to unroll the rolling interface object by causing display of a flat two-dimensional dashboard that includes the plurality of data sets and additional data sets not visible in the rolling interface object.
